(19) United States
(12) Patent Application Publication
(10) Pub. No.: US 2017/0326499 A1
(43) Pub. Date: Nov. 16, 2017

(54) Hybrid FO-EED System for High Salinity Water Treatment

(71) Applicant: NRGTEK, Inc., Orange, CA (US)

(72) Inventor: Subramanian Iyer, Orange, CA (US)

(73) Assignee: NRGTEK, Inc., Orange, CA (US)

(21) Appl. No.: 15/665,732

(22) Filed: Aug. 1, 2017

Related U.S. Application Data
(63) Continuation-in-part of application No. 15/153,688, filed on May 12, 2016.
Application No. 15/153,688 is a continuation-in-part of application No. 15/271,175, filed on Sep. 20, 2016.
Application No. 15/271,175 is a continuation-in-part of application No. 15/272,406, filed on Sep. 21, 2016.
(60) Provisional application No. 62/253,661, filed on Nov. 10, 2015.
(60) Provisional application No. 62/372,762, filed on Aug. 9, 2016.

(51) Int. Cl. B01D 61/00; C02F 1/04; C02F 1/42; C02F 1/44; C02F 9/00

(52) U.S. Cl. CPC B01D 61/002; C02F 1/444; C02F 1/048; C02F 1/445; C02F 1/42; B01D 61/00; C02F 9/00

(57) ABSTRACT

A system for treatment of a brine feed, the system including a hybrid reactor, the reactor having a plurality of forward osmosis membranes configured to permit the passage of a draw solution solute through the middle of the membrane to draw water across the membrane wall from the brine feed so as to generate diluted solute, and a plurality of membrane electrode assemblies configured to separate ions of the salt in the brine feed to concentrate the salt ions, each membrane electrode assembly having an anion exchange membrane and a cation exchange membrane; whereby each membrane electrode assembly houses a plurality of forward osmosis membranes therewithin.

### CORRESPONDING PATENT APPLICATIONS

The present application is a continuation-in-part of Ser. No. 15/153,688, filed May 12, 2016, a U.S. Non-Provisional patent application that claims priority to U.S. Provisional patent application Ser. No. 62/253,661, filed Nov. 10, 2015; a continuation-in-part of Ser. No. 15/271,175, filed Sep. 20, 2016, a U.S. Non-Provisional patent application that claims priority to U.S. Provisional patent application Ser. No. 62/372,762, filed Aug. 9, 2016; and a continuation-in-part of Ser. No. 15/272,406, filed Sep. 21, 2016, the entire contents of each of which are incorporated herein in their entirety by reference.

### BACKGROUND

Forward osmosis (FO) is a technology currently being explored for desalination of seawater. Unlike reverse osmosis (RO) processes, which employ high pressures ranging from 400-1100 psi to drive fresh water through a membrane, forward osmosis uses the natural osmotic pressures of salt or polymer solutions to effect fresh water separation. A ‘draw solution’ having a significantly higher osmotic pressure than the saline feed-water flows along the permeate side of the membrane, and water naturally transports itself across the membrane by osmosis. Osmotic driving forces in FO can be significantly greater than hydraulic driving forces in RO, leading to higher water flux rates and recoveries. Thus, it is a low-pressure system, allowing design with lighter, compact, less expensive materials. These factors translate in considerable savings, both in capital and operational costs.

Joint research by Yale University and Oasys Inc, under an Office of Naval Research grant, compared forward osmosis to reverse osmosis processes, and found superior performance and flux rates. Based on these studies, Oasys developed a patented forward osmosis process, using ammonium bicarbonate aqueous solutions as the draw down liquids in their forward osmosis process. Other FO processes have been proposed, using either magnesium chloride draw solutions, polymeric draw solutions based on polyethylene glycols, volatile solutes like dimethyl amines, sulfur dioxide or aliphatic alcohols, or bivalent/precipitable salts like aluminum sulfate/calcium hydroxide (Modern Water, UK). Glucose or sucrose has been used as solutes for the draw solution, which can then be ingested after suitable dilution (Hydration Technologies International Inc.)

NRGTEK Inc. of Orange, Calif. has developed an alternative FO technology for a low-cost, seawater desalination system. Forward osmosis technology was developed in a low-energy, low-temperature and low-pressure process, using novel organic solutes, called “cloud-point” solutes. Organic solutes of such a nature, typically polyethylene-polypropylene glycol copolymers, or polyethylene glycol fatty acids/alcohols, exhibit a solubility inversion, or cloud point, in the range of 15-55° C., depending on the composition of the organic solute. Thus, while exhibiting high solubility at low temperatures in aqueous solutions, these solutes precipitate or “cloud” out at higher temperatures. These compounds also generate high osmotic pressures in water mixtures, allowing the phenomenon of osmosis to proceed, and the use of the “cloud point” phenomenon enables the solute to be separated out at slightly higher temperatures than the inlet seawater. The use of specifically engineered organic osmotic solute molecules has enabled cloud-point induced, liquid-liquid phase separation to occur at 20° C., 30° C. and 35° C., for feed-water inlet temperatures of 18° C., 28° C. and 33° C., as prevalent in California, Singapore and the Middle East, respectively. Considering that approximately 1 kWh/m³ of energy is required to raise the temperature of water by 1° C., having a cloud point within 2° C. of the feed-water inlet temperature enables low-energy consumption for finished water separation, without use of waste heat or solar heat. This allows the FO-desalination process to be a low-energy desalination route (≦2.0 kWh/m³, as compared to RO processes at 3.5 kWh/m³), with significant cost benefits to the desalination industry.

Electro-dialysis (ED) is a well-established method for the removal of electrolytes from aqueous solutions. It involves the preferential transport of ions through ion exchange membranes under the influence of an electrical field, producing concentrated brines and salt-depleted waters. While conventionally used for treatment of brackish water, desalination of water with higher concentrations of dissolved solids (30-100 g/L, or 30,000-100,000 ppm) to yield potable water can be performed by ED only at high energy costs.

This process has been widely used for production of drinking and process water from brackish water, treatment of industrial effluents, recovery of useful materials from effluents and concentration of acids/salts. Typically, ED cells are arranged in a bi-polar format, in a series configuration. Similarly, electro-electrodialysis (EED) is a technology developed for obtaining concentrated ionic solutions from dilute ionic solutions, using single cells in a parallel configuration, which enables more precision in voltage and amperage control across each cell, as compared to a bi-polar configuration. EED also involves the preferential transport of ions through ion exchange membranes, under the influence of a DC electrical field, producing concentrated acids/bases and salt-depleted water.

In a typical ED cell, a series of anion and cation exchange membranes are arranged in an alternating pattern between an anode and a cathode to form individual cells. When a DC potential is applied between two electrodes, positively charged cations move toward the cathode, pass through the negatively charged cation exchange membrane and are retained by the positively charged anion exchange membrane. On the other hand, negatively charged anions move toward the anode, pass through the positively charged anion exchange membrane and are retained by the negatively charged cation exchange membrane. At the end, ion concentration increases in alternate compartments with a simultaneous decrease of ion concentration in other compartments. However, ED can only remove ionic salts through the anionic and cationic membranes due to electrical potential differences of the system. Any nonionic TDS in the brackish produced water stream needs to be removed in a separate process in pre- or post-treatment.

A newer process, called CEDI (continuous electro-deionization), also includes anionic and cationic exchange resins in the main electrode compartments, in addition to the anionic and cationic membranes lining the periphery of the cells. As the salts ions are transported across the respective membranes, typically at a voltage of around 0.4-0.6 V/cell, the conductivity of the solution decreases, leading to higher amperage needs and corresponding resistance effects. Operating the cell at a higher voltage, around 0.8 V/cell, allows water to break down into H⁺ and OH⁻ ions, which interact with the ion exchange resins in the cell, and restore ionic conductivity in the solution. The applied voltage is insufficient to electrolyze water into hydrogen and oxygen gases, which would ideally require voltages in excess of 1.23 VDC. Thus, the resin acts as an ionic pathway across each individual cell, keeping cell amperage and resistance low. The process is termed continuous, since the resins continuously get regenerated, there is no need for electrode polarity reversal, and product output is constant.

The reject brine flow from a traditional Reverse Osmosis System has a Total Dissolved Solids (TDS) range of 35,000-50,000 ppm or higher, and is untreatable by any of the current methods of water treatment, except thermal distillation processes. Similarly, produced water from oil and gas operations have a similar high TDS level, and is very expensive to treat. As explained below, embodiments of the present invention comprise a novel approach for treatment of, among other things, high-TDS water and conversion to potable or irrigation water, using Hybrid Forward Osmosis-Electroelectrodialysis (FO-EED) technology. Use of such technology can concentrate the brine from a TDS level of 35,000-50,000 to a final TDS level of 250,000-350,000, suitable for down-stream treatment to zero-liquid-discharge (ZLD) processes or spray driers, at low cost and high energy efficiency.

### SUMMARY

In one embodiment, a system is provided for treatment of a brine feed containing at least one salt, the system comprising a hybrid reactor, the reactor comprising at least one membrane electrode assembly configured to separate ions of the salt in the brine feed, each membrane electrode assembly comprising at least one anion exchange membrane and at least one cation exchange membrane; each membrane electrode assembly comprising at least one forward osmosis membrane configured to permit the passage of a draw solution solute through the middle of the membrane to draw water across the membrane wall from the brine feed so as to generate diluted solute and to concentrate the salt ions. In one embodiment, the at least one membrane electrode assembly comprises a plurality of forward osmosis membranes. In one embodiment, the system comprises a hybrid reactor comprising a plurality of membrane electrode assemblies, wherein each membrane electrode assembly comprises a plurality of forward osmosis membranes. In one embodiment, the system comprises a hybrid reactor comprising a collection cell adjacent each side of the at least one membrane electrode assembly, the collection cells configured to recombine separated salt ions to generate a concentrated brine solution. In one embodiment, the system comprises a hybrid reactor comprising a collection cell in between adjacent membrane electrode assemblies, the collection cells configured to recombine separated salt ions to generate a concentrated brine solution. In one embodiment, the system comprises a solute regeneration unit for separating solute in the diluted solute from the water, for return of the solute to the FO membranes.

In one application of embodiments of the present invention, a method is provided of treating a brine feed containing at least one salt, the method comprising directing the brine feed and a solute into a hybrid reactor, the hybrid reactor comprising a plurality of membrane electrode assemblies, each containing a plurality of forward osmosis membranes; drawing water from the brine feed across the forward osmosis membranes to generate a diluted solute; separating the salt into its ion constituents and, under an electrical potential, directing the anions through an anion exchange membrane and directing the cations through a cation exchange membrane; recombining anions with cations to generate a concentrated brine solution; and regenerating solute by separating water from the diluted solute. In one embodiment, recombining anions with cations takes place within a collection cell in between adjacent membrane electrode assemblies.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 shows a schematic view of one embodiment of processing system;

FIG. 2 shows a schematic view of one side of one embodiment of a hybrid FO-EED system;

FIG. 3 shows a schematic view of one end of one embodiment of the hybrid FO-EED system of FIG. 2.

### DETAILED DESCRIPTION OF CERTAIN EMBODIMENTS

The present invention comprises embodiments that include a hybrid Hollow Fiber FO-ED system with low energy consumption in the treatment of the saline water to produce highly saline water, with TDS levels of 250,000-350,000. Embodiments include high-efficiency FO-ED membrane structures, with FO hollow fibers incorporated as the separation matrix and sandwiched between the ED anionic and cationic structures. If the ED process is integrated with a forward osmosis (FO) process, the desalination is primarily effected by the FO membranes, while the ionic salts migrate towards the anionic and cationic membranes under an applied electric potential. The FO process now essentially works on the osmotic potential difference between fresh water and the osmotic draw solution, since the ions in the inlet brine have been drawn away from the vicinity of the FO membranes due to the application of a D.C. electrical field. The high osmotic differential between the osmotic polymer draw solution and fresh water results in higher flux rates and greater water recovery from the inlet saline feed solution. The end result is a very low volume of concentrated brine (˜5-10%) as the effluent, with almost 90-95% of the inlet saline water treated to environmentally useable levels, at economic costs lower than the competing processes of thermal distillation (MED, MSF or Mechanical Vapor Compression) and other conventional processes.

Commercially available solid polymer membranes do not have sufficient electrochemical conductivity for efficiently de-ionizing large amounts of salt without a substantial energy penalty. New ion-exchange membranes with electrochemical conductivity higher by a hundred-fold are described in non-provisional application Ser. No. 15/153,688 filed May 12, 2016, the entire contents of each of which are incorporated herein in its entirety by reference. Porous gelled liquid electrolyte membranes have properties intermediate between liquid electrolytes and solids-state electrolyte membranes. These membranes have interconnected pores, filled with the desired ionic species, which is held inside the pores by capillary forces. The pores are typically between 1-10 microns, and the porous polymer gel may have porosity between 85-90%. The polymers typically used for forming the porous membrane structures are well-known in literature, and range from polyethylene oxide (PEO), polyacrylonitrile (PAN), polydimethylsiloxane (PDMS), polyvinylidene difluoride (PVDF), poly(methyl-methlyacrylate) (PMMA) and other polymers. Some membranes cited in literature are also made from mixtures of these polymers with each other and other polymers. Thus, a few examples of porous membrane structures suitable for gelled electrolyte membranes are PVDF-HFP (PVDF-co-hexafluoropropylene) membranes, PDMS-PAN-PEO membranes, PVDF-NMP-EC-PC (PVDF with n-methylpyrilodine and ethylene and propylene carbonate) and even PVDF on glass mats. Such porous membranes, in which saturated solutions of ionic species have been absorbed, have much higher electrochemical conductivity than conventional solid-state membranes. Other suitable electrode structures would be porous carbon matrices, porous graphitic structures, carbon aerogels, carbon nanotubes and graphene.

In one application, a process for the treatment of saline water is provided to produce an ultra-high TDS reject stream and a substantially pure water stream. Pre-treated seawater or industrial saline waste water, after removal of non-ionic TDS content, is directed to an FO-EED system. Simultaneously, a concentrated polymeric draw solution is directed to the FO membranes in the FO-EED system. Under the application of a DC electrical feed, the salt ions move into the porous MEA matrices of the EED system, substantially concentrating the salt solution reject from the EED system. The DC electrical energy for the EED system can be either from a solar photovoltaic system or from the electrical grid.

At the same time, fresh water is pulled through the FO membranes into the concentrated polymeric draw solution, thereby diluting the polymeric draw solution. The diluted polymeric draw solution, now consisting of a water-polymer mixture, is subsequently directed to a polymer regeneration unit, as described in US non-provisional patent application Ser. No. 15/272,406 filed Sep. 21, 2016, the entire contents of which are incorporated herein in its entirety by reference.

In the polymer regeneration unit, the application of heat, either from solar thermal or waste heat sources, causes the mixture to phase-separate into two solutions, one polymer-rich and the other water-rich. The polymer-rich mixture is directed into a heat exchanger and then to a concentrated polymer tank for recycling to the FO-EED system. The water-rich stream is directed to a filtration system, either a nano-filtration or a loose RO membrane module, to extract any remnant polymer from the water-rich stream. The permeate from the filtration system is an ultra-low TDS water stream, suitable for potable water or industrial/agriculture uses. The hyper-saline reject from the FO-EED system, if needed, can be directed the polymer heat exchanger, to cool down the concentrated polymer to ambient temperature. In turn, the hyper-saline water is heated to high temperatures, suitable for being used in a crystallizer for a Zero-Liquid-Discharge (ZLD) process, or to a spray drier, to obtain crystalline or anhydrous salt mixtures for subsequent disposal or reuse.

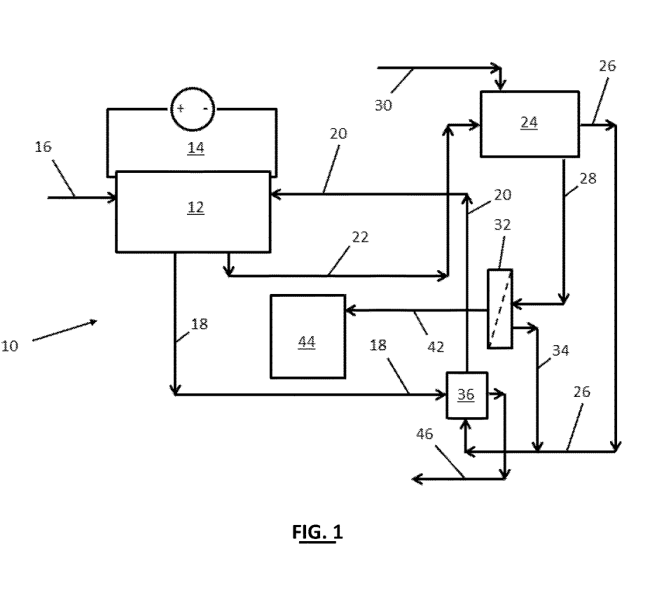

Referring to FIG. 1, one embodiment of the system and process can be described more specifically. System 10 comprises a hybrid FO-EED reactor 12 powered by, for example, DC power 14 from solar PV or grid-based rectifiers. High salinity water 16 is directed into the hybrid FO-EED reactor 12 and exits as a concentrated brine reject that can be used downstream in a heat exchanger, as described further below. A draw solution solute 20, which can be one or more of any of the types described herein, including a polymer, is directed also into the hybrid FO-EED reactor 12 to draw pure water from the high salinity water 16 across an FO membrane (not shown). The solute-water mixture 22 then exits from the hybrid FO-EED reactor 12 for regeneration.

In one embodiment, regeneration can take place using a polymer regeneration unit 24, which separates polymer 26 from the water 28. In one embodiment, the polymer regeneration unit 24 can be provided with heat 30 in the form of solar thermal or waste heat. Other types of systems for separating solute from water are also contemplated. The separated water 28 can be directed into, for example, a nano-filtration unit 32 from which any residual polymer 34 can be extracted and joined with the separated polymer 26 from the regeneration unit 24. The regenerated polymer 26 can then be directed into a heat exchanger 36 cooled by the concentrated brine 18 from the hybrid FO-EED reactor 12. The output of the heat exchanger 36 is regenerated cooled solute 20 that can then be used to be reintroduced into the hybrid FO-EED reactor 12. The separated water 42 from the nano-filtration unit 32 can then be directed to a storage vessel 44 for later handling. The hot brine reject 46 from the heat exchanger 36 can be directed elsewhere for further processing. It is contemplated that the industrial use of such a process, as shown in FIG. 1, will enable treatment of seawater and saline waste water streams, starting at an inlet TDS of 35,000-70,000, and concentrate the inlet to a final reject stream with TDS of 250,000-350,000, while extracting fresh water of suitable quality to satisfy potable water and industrial water requirements with minimal post-treatment.

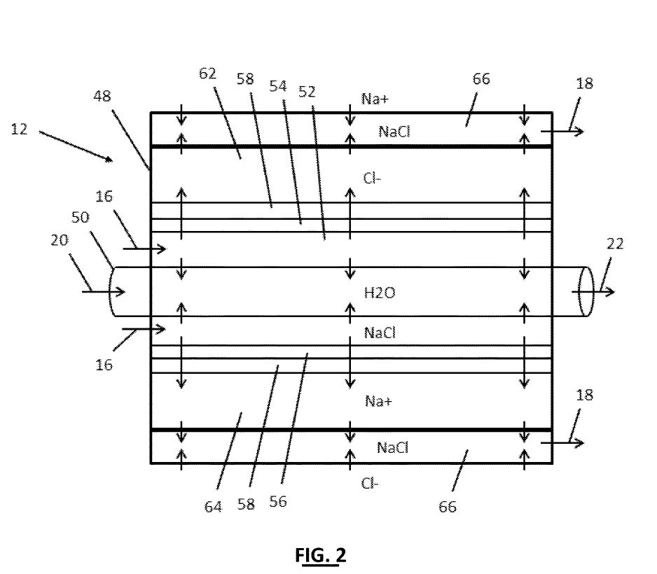

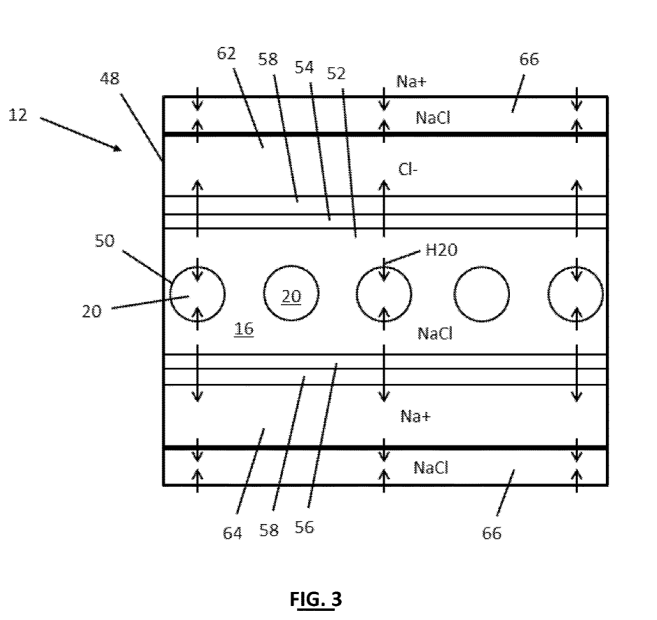

Referring to FIGS. 2 and 3, one example of a specific embodiment of hybrid FO-EED reactor 12 can be described comprising a hybrid FO-EED chamber 48 (i.e., membrane electrode assembly) comprising at least one forward osmosis (e.g., hollow fiber) membrane 50 through which solute 20 can be directed. In some embodiments, a membrane electrode assembly (hybrid FO-EED chamber) 48 comprises a plurality of forward osmosis membranes 50 (see FIG. 3). The hollow fiber membrane 50 can be a cylindrical tube, as shown, or a flat sheet that is formed to create a sealed volume through which the draw solution solute can be directed. The hollow fiber membrane 50 is positioned within a first area 52 of the FO-EED chamber 48 into which the high salinity water 16 is directed. As described above, the osmotic pressure of the solute 20 draws water from the high salinity water 16 across the membrane 50 to mix with the solute 20, which exits the hollow fiber membrane as a water-solute mixture 22 (i.e., diluted solute) for regeneration. FIG. 2 shows a side view showing only one hollow fiber membrane 50, while FIG. 3 shows an end view showing multiple hollow fiber membranes 50, all of which are encapsulated within its own cell and electrode membrane assembly.

In the case of high salinity water 16 having NaCl salts, by example, the NaCl salt is left behind in the first area 52 of the cell 48 and separated into its constituent ions of Na+ and Cl−, with the Cl− directed across an anion exchange membrane 54 and the Na+ directed across a cation exchange membrane 56. The Cl− is directed across an electrode mesh 58 into a second area 62 of FO-EED chamber 48 where Cl− is collected. The Na+ is directed across an electrode mesh 58 into a third area 64 of FO-EED chamber 48 where the Na+ is collected. Adjacent FO-EED chamber 48 are collection cells 66 into which the Cl− and Na+ are directed across ion-exchange membranes to recombine as NaCl in concentrated form 18 for later processing.

The pre-treated (after removal of non-ionic TDS content) feed saline water is fed in the space between the ED membrane electrode assembly (MEAs), while the concentrated FO polymeric draw solution is fed into the hollow fibers interspaced between the ion membranes. The osmotic pressure of the draw solution flowing within the FO hollow fibers pulls fresh water from the saline feed water into the hollow fibers, while a DC electrical gradient simultaneously forces the salt anions and cations away from the hollow fibers to their corresponding ion exchange membrane electrode assemblies. The movement of the ions in the feed water away from the hollow fibers leaves a low-TDS water layer in the vicinity of the hollow fibers. The water permeates through the FO hollow fibers into the FO draw solution, under the now enhanced osmotic pressure gradient, essentially the gradient between the osmotic potential of the FO draw solution versus low-TDS water. As the ions move away from the vicinity of the hollow fibers towards the adjacent membranes, the cleaner water and reduced osmotic pressure on the hollow fiber surface enables increased permeation of water into the polymeric draw solution, with high flux rates. In other words, separating the ions leads to a great flux rate across the wall of the forward osmosis membrane. The hollow fibers are themselves around 0.6-0.8 mm in diameter, considerably lower than the traditional 1.2 mm separation matrix in conventional ED membranes used in industry, thus reducing electrical resistance requirements. The thinner diameter of the hollow fibers and the high conductivity of the inlet feed solution serves to reduce overall energy consumption for the ED process, while the enhancement of the osmotic potential difference between the osmotic draw solution and the substantially pure water layer adjacent to the hollow fiber FO membranes enables water to be easily pulled across these membranes into the FO draw solution with high flux rates.

It is contemplated that a number of FO-EED chambers 48 can be joined together into a plurality of membrane-electrode assemblies, with each FO-EED chamber 48 separated by a collection cell 66 to permit the processing of large quantities of high salinity water 16. The FO membranes allow only water to cross the hollow fiber membrane from the feed water chamber. In the FO-EED chamber, direct current provides the electrical gradient for each ion to cross through its corresponding ion exchange membrane into an adjacent chamber, where they recombine to form concentrated brine. The combination of ED with the hollow fiber FO membrane elements enables complete salt removal in the product diluted draw solution. The diluted polymeric draw solution permeating through the hollow fibers is subsequently re-concentrated to a feed draw solution, as described in U.S. non-provisional patent application Ser. No. 15/272,406 filed Sep. 21, 2016, the entire contents of which are incorporated herein in its entirety by reference.

If the membrane-electrode assemblies are integrated with porous membranes and electrodes, the two anionic and cationic streams can re-mix to form concentrated salt solutions as the reject flows from the FO-ED system, without expenditure of electrical energy for acid/base formation, since no salt splitting occurs. Electrical re-configuration to operate the cells in a parallel mode enables the system to function as an FO-EED module, enabling more precise control of voltage and amperage across each cell, and thus results in increased salt concentration in the MEAs. Hollow fiber membranes are utilized as they provide a higher surface area for the diffusion of water across the surface of the membrane, as compared to flat sheet membranes used in conventional FO systems, though flat sheet membrane structures could also be used, in place of the hollow fibers. The tubular hollow fiber membranes or flat sheet membranes can be configured to be supported and secured in place as a flow spacer between the anion and cation exchange membranes in the EED stack design.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for treatment of a brine feed containing at least one salt, the system comprising a hybrid reactor, the reactor comprising at least one membrane electrode assembly configured to separate ions of the salt in the brine feed, each membrane electrode assembly comprising at least one anion exchange membrane and at least one cation exchange membrane; each membrane electrode assembly comprising at least one forward osmosis membrane configured to permit the passage of a draw solution solute through the middle of the membrane to draw water across the membrane wall from the brine feed so as to generate diluted solute and concentrated salt ions.

2. The system of claim 1, wherein the at least one membrane electrode assembly comprises a plurality of forward osmosis membranes.

3. The system of claim 1, wherein the hybrid reactor comprises a plurality of membrane electrode assemblies, wherein each membrane electrode assembly comprises a plurality of forward osmosis membranes.

4. The system of claim 1, wherein the hybrid reactor comprises a collection cell adjacent each side of the at least one membrane electrode assembly, the collection cells configured to recombine separated salt ions to generate a concentrated brine solution.

5. The system of claim 3, further comprising a collection cell in between adjacent membrane electrode assemblies, the collection cells configured to recombine separated salt ions to generate a concentrated brine solution.

6. The system of claim 2, further comprising a solute regeneration unit for separating solute in the diluted solute from the water, for return of the solute to the FO membranes.

7. A method of treating a brine feed containing at least one salt, the method comprising:
directing the brine feed and a solute into a hybrid reactor, the hybrid reactor comprising a plurality of membrane electrode assemblies, each containing a plurality of forward osmosis membranes;
drawing water from the brine feed across the forward osmosis membranes to generate a diluted solute;
separating the salt into its ion constituents and, under an electrical potential, directing the anions through an anion exchange membrane and directing the cations through a cation exchange membrane;
recombining anions with cations to generate a concentrated brine solution; and
regenerating solute by separating water from the diluted solute;

8. The method of claim 7 wherein recombining anions with cations takes place within a collection cell in between adjacent membrane electrode assemblies.
